(19) United States
(12) Patent Application Publication
(10) Pub. No.: US 2026/0098164 A1
(43) Pub. Date: Apr. 9, 2026

(54) INKJET INK

(71) Applicant: KYOCERA DOCUMENT SOLUTIONS INC., OSAKA (JP)

(72) Inventor: YUMA NAKAE, OSAKA (JP)

(21) Appl. No.: 19/348,758

(22) Filed: Oct. 2, 2025

(30) Foreign Application Priority Data
Oct. 8, 2024 (JP) 2024-176375

(51) Int. Cl. C09D 11/30; C09D 11/107

(52) U.S. Cl. CPC C09D 11/30; C09D 11/107

(57) ABSTRACT

An inkjet ink includes: a pigment, a water-based solvent, an alkaline agent, and a dispersion resin. The dispersion resin is a block polymer that includes a hydrophobic polymer block including benzylmethacrylate and a hydrophilic polymer block including methacrylic acid. The block polymer has an acid value of 120 mg KOH/g or more and 200 mg KOH/g or less. The water-based solvent has a log Kow of 0 or more.

### CROSS-REFERENCE TO RELATED PATENT APPLICATION

This application claims the benefit of Japanese Priority Patent Application JP 2024-176375 filed Oct. 8, 2024, the entire contents of which are incorporated herein by reference.

### FIELD OF THE DISCLOSURE

The present disclosure relates to an inkjet ink.

### BACKGROUND OF THE DISCLOSURE

Inkjet ink are desired to have even higher quality with the recent improvement in the quality of inkjet printers. For example, Japanese Patent Application Laid-open No. 2012-36251 discloses an aqueous pigment dispersion liquid for inkjet having excellent long-term preservation stability and ejection stability of ink and excellent print quality with high color development on plain paper by using a block polymer that includes a methacrylate-based hydrophobic polymer block and a hydrophilic polymer block containing methacrylic acid.

### SUMMARY OF THE DISCLOSURE

An inkjet ink according to an embodiment of the present disclosure includes: a pigment; a water-based solvent; an alkaline agent; and a dispersion resin.

The dispersion resin is a block polymer that includes a hydrophobic polymer block including benzylmethacrylate and a hydrophilic polymer block including methacrylic acid.

The block polymer has an acid value of 120 mg KOH/g or more and 200 mg KOH/g or less.

The water-based solvent has a log Kow of 0 or more.

### DETAILED DESCRIPTION OF THE EXEMPLARY EMBODIMENTS

An embodiment of the present disclosure will be described below.

### [Configuration of Ink]

### (Schematic Configuration)

An inkjet ink according to an embodiment of the present disclosure (hereinafter, referred to simply also as an “ink”) is ejected onto a recording medium from a recording head of an inkjet recording apparatus to record an image on the recording medium. Examples of the recording medium on which an image is recorded by the ink according to this embodiment include plain paper, copy paper, recycled paper, thin paper, thick paper, glossy paper, and OHP.

The ink according to this embodiment is a water-based ink that includes a pigment, a water-based solvent, an alkaline agent, and a dispersion resin. The dispersion resin is a block polymer that includes a hydrophobic polymer block including benzylmethacrylate and a hydrophilic polymer block including methacrylic acid. The block polymer has an acid value of 120 mg KOH/g or more and 200 mg KOH/g or less, and the water-based solvent has a log Kow of 0 or more.

In order to improve print density in inkjet printing, methods such as retaining a pigment on paper and causing a pigment to react with a paper filler can be adopted. When a pigment is caused to react with a paper filler to achieve print density, there are limitations imposed on the paper. Meanwhile, when a pigment is retained on paper, print density can be achieved independent of the sheet of paper. However, when a pigment is retained on paper, generally, a method of agglomerating the pigment on the paper surface is often adopted. One method of agglomerating the pigment is to add a relatively hydrophobic solvent to the solvent composition of the ink. By adding the hydrophobic solvent to the solvent composition of the ink, the dispersion resin is easily released from the pigment, and the pigments agglomerate when the dispersion resin is released. However, in this case, since the ink also includes a hydrophobic solvent, achieving bot solvent resistance and print density in the liquid is a major challenge. Note that in the invention described in the Background, the solvent type is limited to hydrophilic organic solvents having a log Kow of 0 or less, and the selection of the solvent type is not considered in the preparation of the ink. On the other hand, according to the ink according to this embodiment, it is possible to achieve both solvent resistance and print density.

For example, when using a solvent having a log Kow of 0 or more, the dispersion resin is released from the pigment in the liquid, causing the agglomeration and sedimentation of pigments. However, by using the dispersion resin according to the present disclosure, it is possible to strengthen the adsorption on the pigment and achieve solvent resistance. Meanwhile, water evaporates on the paper surface and the relatively hydrophobic solvent having a log Kow of 0 or more becomes enriched, thereby causing the pigment to agglomerate and achieving favorable print density. As a result, it is possible to provide an ink that is capable of providing solvent resistance in the liquid and achieving favorable print density by the agglomeration of pigments on the paper surface. The details thereof will be described below.

### (Pigment)

The water-based ink used in this embodiment includes a pigment as a coloring agent from the viewpoints of color mixing prevention of a printed matter and improvement in water resistance. The pigment may be either an inorganic pigment or an organic pigment. Further, these may be combined with an extender pigment as necessary.

Examples of the inorganic pigment include carbon black and metal oxide. In particular, in the case of a black ink, carbon black is favorable. Examples of the carbon black include furnace black, thermal lamp black, acetylene black, and channel black.

Specific examples of the organic pigment include an azo pigment, a diazo pigment, a phthalocyanine pigment, a quinacridone pigment, an isoindolinone pigment, a dioxazine pigment, a perylene pigment, a perinone pigment, a thioindigo pigment, an anthraquinone pigment, and a quinophthalone pigment.

The hue is not particularly limited, and a colored pigment such as yellow, magenta, cyan, blue, red, orange, and green can be used. Specific examples of the favorable organic pigment include one or more products selected from the group consisting of C.I. Pigment Yellow, C.I. Pigment Red, C.I. Pigment Orange, C.I. Pigment Violet, C.I. Pigment Blue, and C.I. Pigment Green.

### (Dispersion Resin)

The dispersion resin used in this embodiment is a polymer dispersant in which the A block is a hydrophobic block polymer and the B block is a hydrophilic block polymer (hereinafter, referred to also as an AB block polymer). In this example, the A block is benzylmethacrylate that is a hydrophobic block polymer, and the B block is methacrylic acid that is a hydrophilic block polymer. This AB block polymer can be obtained by living radical polymerization.

Regarding each of the A and B polymer blocks, the hydrophobic A block is adsorbed on the pigment surface and plays a role of coating the pigment while the hydrophilic B block has the carboxyl group to be ionized by an alkaline agent and plays a role of dissolving in the water-based solvent. The ionized carboxyl group has electrostatic repulsive force, thereby maintaining the dispersion stability in the liquid in combination with the three-dimensional obstacles of the dispersion resin structure. By using such an AB block polymer, it is possible to specialize the function of the hydrophobic A block for being adsorbed on the pigment and the function of the hydrophilic B block for electrostatic repulsive force and three-dimensional repulsive force.

The AB block polymer that is a dispersion resin used in this embodiment has an acid value of 120 mg KOH/g or more and 200 mg KOH/g or less.

In the low acid value region having an acid value of less than 120 mg KOH/g, the amount of methacrylic acid that is an acid component is low, and therefore the electrostatic repulsive force and the three-dimensional repulsive force becomes smaller, making it difficult to achieve solvent resistance when a hydrophobic solvent is included. Further, in the high acid value region having an acid value of exceeding 200 mg KOH/g, the amount of methacrylic acid that is an acid component is high, the pigment becomes difficult to agglomerate even on the paper surface, and print density cannot be achieved. That is, the acid value of the dispersion resin capable of achieving both solvent resistance and print density is 120 mg KOH/g or more and 200 mg KOH/g or less.

The acid value can be obtained by, for example, the method according to JIS K 0070:1992 “Test methods for acid value, saponification value, ester value, iodine value, hydroxyl value and unsaponifiable matter of chemical products”.

Note that even if the acid value of the dispersion resin is within the above range, when the dispersion resin is a random polymer and the water-based solvent is hydrophobic, the pigment agglomerates, resulting in poor solvent resistance and inability to achieve print density. For this reason, when a hydrophobic solvent is used as a water-based solvent, the dispersion resin is favorably the above-mentioned benzylmethacrylate/methacrylic acid block polymer.

### (Water-Based Solvent)

As a water-soluble solvent constituting the water-based solvent, a relatively hydrophobic solvent having a log Kow of 0 or more is favorable. Examples of this type of solvent include 1,2-pentanediol (log Kow: 0.01), butyl triglycol (same, 0.02), 3-methyl-1,5-pentanediol (same, 0.03), 2-propanol (same, 0.05), dimethyl ether (same, 0.1), 1-propanol (same, 0.25), diethylene glycol diethyl ether (same, 0.39), and triethylene glycol monobutyl ether (same, 0.44).

As water constituting the water-based solvent, for example, ion exchanged water, purified water, distilled water, or the like can be used.

Note that the log Kow is a water/octanol coefficient. The above numerical value of log Kow is a numerical value calculated using Hansen Solubility Parameter in Practice (HSPiP) software.

### (Alkaline Agent)

The alkaline agent constituting the pigment dispersion liquid in this embodiment is used to solubilize the dispersion resin formed of the above block polymer in the water-soluble solvent. The alkaline agent to be used is not particularly limited, but a compound selected from the group consisting of alkali metal hydroxides such as NaOH and KOH can be suitably used.

### (Other Components)

Components other than the above, e.g., a surfactant or a moisturizing agent, may be blended in the ink according to this embodiment.

The surfactant has the effect of enhancing the wettability of the ink on a recording medium and the effect of enhancing the compatibility and dispersion stability of each component included in the ink. As the surfactant, a nonionic surfactant is favorable. Further, the surfactant imparts appropriate dynamic surface tension to the ink.

### [Preparation of Ink]

The method of preparing the ink according to this embodiment includes, for example, a dispersion step of dispersing a dispersion resin and a pigment in water to prepare a pigment particle dispersion liquid and an addition step of adding an aqueous medium to the pigment particle dispersion liquid to prepare an ink.

### (Dispersion Step)

In this step, a pigment and a dispersion resin are dispersed in water to prepare a pigment dispersion liquid. The content ratio of the pigment and the dispersion resin (mass ratio of the pigment/the dispersion resin) is favorably 60/40 to 90/10.

That is, the ratio of the mass of the dispersion resin to the mass of the pigment is favorably 0.1 or more and 0.4 or less. When the ratio of the mass of the dispersion resin to the mass of the pigment is 0.4 or less, the viscosity of the pigment dispersion liquid and the ink can be easily adjusted to a desired value. When the ratio of the mass of the dispersion resin to the mass of the pigment is 0.1 or more, an ink having excellent dispersion stability can be obtained.

A pigment dispersion liquid was prepared such that the composition shows in Table 1 was achieved. In this example, the dispersion resin was 6 mass %, the alkaline agent was 0 to 1 mass %, the pigment was 15 mass %, OLFINE (registered trademark) E1010 was 0.5 mass %, and water was the remaining amount.

TABLE 1

| | Mass % |
|---|---|
| Dispersion resin | 6.0 |
| NaOH (alkaline agent) | 0~1.0 |
| Pigment (P.B-15:3) FG-7351 (Toyocolor Co., Ltd.) | 15 |
| OLFINE E1010 | 0.5 |
| Water | Remainder |
| | 100 |

The pigment was C.I. Pigment Blue 15:3 (PB15:3) (“LIONOL BLUE FG-7351” manufactured by Toyocolor Co., Ltd.). OLFINE (registered trademark) E1010 (ethylene oxide adduct of acetylenediol) is a dispersant or a surfactant for enhancing the dispersibility of a pigment. The alkaline agent (NaOH) was added in an amount that neutralizes the dispersion resin at 105% equivalent.

Examples of the dispersing apparatus to be used for dispersion treatment include a wet dispersing apparatus such as a media disperser such as Nano Grain Mill manufactured by ASADA IRON WORKS. CO., LTD., MSC mill manufactured by NIPPON COKE & ENGINEERING. CO., LTD., and “DYNO (registered trademark)-MILL” manufactured by Shinmaru Enterprises Corporation. As the dispersion conditions, small-diameter beads (0.5 mm q zirconia beads) were set in a vessel, the ejection rate was controlled at 200 to 600 g/min, and a pigment dispersion liquid was prepare such that the average particle diameter was 90 to 110 nm as the dispersion particle size of the pigment dispersion.

Note that the degree of dispersion and the amount of free resin were varied by changing the type of beads. It goes without saying that using a smaller bead diameter makes it easier to achieve micronization, and enhances the coating strength of the resin on the pigment. For measurement of the particle size distribution, a solution diluted 300 times with ion exchanged water was measured using Zetasizer Nano manufactured by Sysmex Corporation.

### (Addition Step)

In this step, a water-based solvent is added to the pigment dispersion liquid prepared as described above. As a result, an ink is obtained. The content of the water-based solvent is favorably 20 to 35 mass %. Note that in this step, another component (more specifically, at least one of a surfactant, a dissolution stabilizer, an anti-drying agent, an antioxidant, a pH adjuster, a moisturizing agent, a penetrating agent, an antifungal agent, or a viscosity adjustor) may be further added as necessary. In this step, after adding the aqueous medium, it is favorable to stir the obtained mixed solution using a stirrer. The obtained ink may be filtered using a filter (e.g., a filter having a pore size of 5 μm or less) to remove foreign substances and coarse particles.

An ink was prepared by adding each solvent to a pigment dispersion liquid in order while stirring them using a stirrer such that the composition shown in Table 2 was achieved. In this example, the pigment dispersion liquid was 53.3 mass % (8 mass % of the pigment), the surfactant was 0.5 mass %, the water-based solvent was 30 mass %, glycerin as a moisturizing agent was 10 mass %, and water was the remaining amount.

TABLE 2

| | Mass % |
|---|---|
| Pigment dispersion liquid | 53.3 (Pig 8%) |
| Surfactant | 0.5 |
| Water-based solvent | 30 |
| Glycerin (moisturizing agent) | 10 |
| Water | Remainder |
| | 100 |

### EXAMPLES

Examples of the present disclosure will be described below.

First, a plurality of dispersion resins 1 to 6 having different acid values were prepared as shown in Table 3, and pigment dispersion liquids including the prepared dispersion resins 1 to 6 were prepared such that the composition shown in Table 1 was achieved.

TABLE 3

| | Polymer | Acid value[mgKOH/g] |
|---|---|---|
| Dispersion resin 1 | Random | 160 |
| Dispersion resin 2 | Block | 80 |
| Dispersion resin 3 | Block | 120 |
| Dispersion resin 4 | Block | 160 |
| Dispersion resin 5 | Block | 200 |
| Dispersion resin 6 | Block | 240 |

The dispersion resin 1 is a random polymer having an acid value of 160 mg KOH/g. The dispersion resin 2 is a block polymer having an acid value of 80 mg KOH/g. The dispersion resin 3 is a block polymer having an acid value of 120 mg KOH/g. The dispersion resin 4 is a block polymer having an acid value of 160 mg KOH/g. The dispersion resin 5 is a block polymer having an acid value of 200 mg KOH/g. The dispersion resin 6 is a block polymer having an acid value of 240 mg KOH/g.

### Example 1

A pigment dispersion liquid including the dispersion resin 3 was prepared, and its solvent resistance was evaluated in accordance with the following conditions. Further, an ink having the composition shown in Table 2 was prepared using a pigment dispersion liquid including the dispersion resin 3, and its print density was evaluated in accordance with the following conditions. Note that 3-methyl-1,5-pentanediol (log Kow: 0.03) was used as the water-based solvent in Table 2.

### (Evaluation of Solvent Resistance)

In the evaluation of solvent resistance, first, the particle size distribution of the pigment particle was measured to obtain a 50% cumulative volume particle size (initial D50). Subsequently, a liquid including 1 mass % of a pigment dispersion liquid, 40 mass % of 3-methyl-1,5-pentanediol and 40 mass % of butyl triglycol as hydrophobic solvents, and the remaining amount of water was prepared in a 9 mL screw tube, and allowed to stand at 40° C. for 1 hour. After that, the particle size thereof was measured, the 50% cumulative volume particle size (post-heating D50) was obtained, and the change amount from the particle size (initial D50) of only the pigment dispersion liquid was obtained. When the change amount in particle size was 5 nm, it was evaluated to “Pass (A)”. When the change amount in particle size exceeded 5 nm, it was evaluated to “Fail (B)”.

### (Evaluation of Print Density)

In the evaluation of print density, adjustment was performed with a drive voltage such that 1 dot corresponded to 12 pl, and 10×10 cm solid image was created on A4-size copy paper (“CC90” manufactured by Mondi plc). Further, 12 hours after, the image density (ID) of the solid image was measured using a reflection densitometer (FD-9, manufactured by Konica Minolta, Inc.). When ID was 1.3 or more, it was evaluated to “Pass (A)”. When ID was less than 1.3, it was evaluated to “Fail (B)”.

### Example 2

A pigment dispersion liquid including the dispersion resin 4 was prepared, and its solvent resistance was evaluated in accordance with the same conditions as those in Example 1. Further, a pigment dispersion liquid including the dispersion resin 4 was used to prepare an ink having the composition shown in Table 2, and its print density was evaluated in accordance with the same conditions as those in Example 1.

### Example 3

A pigment dispersion liquid including the dispersion resin 5 was prepared, and its solvent resistance was evaluated in accordance with the same conditions as those in Example 1. Further, a pigment dispersion liquid including the dispersion resin 5 was used to prepare an ink having the composition shown in Table 2, and its print density was evaluated in accordance with the same conditions as those in Example 1.

### Comparative Example 1

A pigment dispersion liquid including the dispersion resin 1 was prepared, and its solvent resistance was evaluated in accordance with the same conditions as those in Example 1. Further, a pigment dispersion liquid including the dispersion resin 1 was used to prepare an ink having the composition shown in Table 2, and its print density was evaluated in accordance with the same conditions as those in Example 1.

### Comparative Example 2

A pigment dispersion liquid including the dispersion resin 2 was prepared, and its solvent resistance was evaluated in accordance with the same conditions as those in Example 1. Further, a pigment dispersion liquid including the dispersion resin 2 was used to prepare an ink having the composition shown in Table 2, and its print density was evaluated in accordance with the same conditions as those in Example 1.

### Comparative Example 3

A pigment dispersion liquid including the dispersion resin 6 was prepared, and its solvent resistance was evaluated in accordance with the same conditions as those in Example 1. Further, a pigment dispersion liquid including the dispersion resin 6 was used to prepare an ink having the composition shown in Table 2, and its print density was evaluated in accordance with the same conditions as those in Example 1.

### Conclusion

The evaluation results of solvent resistance and print density for Examples 1 to 3 and Comparative Examples 1 to 3 are collectively shown in Table 4.

TABLE 4

| | Dispersion | Solvent | Print | |
|---|---|---|---|---|
| | resin | resistance | density | Determination |
| Example 1 | 3 | A | 1.31 | A |
| Example 2 | 4 | A | 1.32 | A |
| Example 3 | 5 | A | 1.33 | A |
| Comparative | 1 | B | 1.29 | B |
| Example 1 | | | | |
| Comparative | 2 | B | 1.3 | A |
| Example 2 | | | | |
| Comparative | 6 | A | 1.27 | B |
| Example 3 | | | | |

As shown in Table 4, in Examples 1 to 3, both solvent resistance and print density were evaluated to “Pass (A)”, confirming that both solvent resistance and print density could be achieved simultaneously. That is, it can be said that by using a benzylmethacrylate/methacrylic acid block polymer having an acid value of 120 mg KOH/g or more and 200 mg KOH/g or less, both solvent resistance and print density can be achieved simultaneously.

On the other hand, in Comparative Example 1 in which the dispersion resin is a random polymer, solvent resistance was poor and print density could not be achieved because the pigment agglomerates when the water-based solvent is hydrophobic. Further, in Comparative Example 2 in which the acid value is low (less than 120 mg KOH/g), solvent resistance was poor. In Comparative Example 3 in which the acid value is high (exceeding 200 mg KOH/g), print density could not be achieved.

### Example 4

A pigment dispersion liquid including the dispersion resin 4 was prepared, and its solvent resistance was evaluated in accordance with the same conditions as those in Example 1. Further, a pigment dispersion liquid including the dispersion resin 4 was used to prepare an ink having the composition shown in Table 2, and its print density was evaluated in accordance with the same conditions as those in Example 1. Note that butyl triglycol (log Kow: 0.02) was used as the water-based solvent in Table 2.

### Example 5

A pigment dispersion liquid including the dispersion resin 4 was prepared, and its solvent resistance was evaluated in accordance with the same conditions as those in Example 1. Further, a pigment dispersion liquid including the dispersion resin 4 was used to prepare an ink having the composition shown in Table 2, and its print density was evaluated in accordance with the same conditions as those in Example 1. Note that 2-propanol (log Kow: 0.05) was used as the water-based solvent in Table 2.

### Comparative Example 4

A pigment dispersion liquid including the dispersion resin 4 was prepared, and its solvent resistance was evaluated in accordance with the same conditions as those in Example 1. Further, a pigment dispersion liquid including the dispersion resin 4 was used to prepare an ink having the composition shown in Table 2, and its print density was evaluated in accordance with the same conditions as those in Example 1. Note that propylene glycol (log Kow: −0.92) was used as the water-based solvent in Table 2.

### Comparative Example 5

A pigment dispersion liquid including the dispersion resin 4 was prepared, and its solvent resistance was evaluated in accordance with the same conditions as those in Example 1. Further, a pigment dispersion liquid including the dispersion resin 4 was used to prepare an ink having the composition shown in Table 2, and its print density was evaluated in accordance with the same conditions as those in Example 1. Note that 2-pyrrolidone (log Kow: −0.71) was used as the water-based solvent in Table 2.

### Conclusion

The evaluation results of solvent resistance and print density for Examples 4 and 5 and Comparative Examples 4 and 5 are collectively shown in Table 5.

TABLE 5

| | Water-based | | Print | |
|---|---|---|---|---|
| | solvent | logKow | density | Determination |
| Example 4 | Butyl triglycol | 0.02 | 1.31 | A |
| Example 5 | 2-propanol | 0.05 | 1.33 | A |
| Comparative | Propylene glycol | −0.92 | 1.27 | B |
| Example 4 | | | | |
| Comparative | 2-pyrrolidone | −0.71 | 1.28 | B |
| Example 5 | | | | |

In Examples 4 and 5, since the ink includes a hydrophobic water-based solvent, the pigment agglomerated on the paper surface, resulting in print density of 1.3 or more. On the other hand, in Comparative Examples 4 and 5, since the ink does not include a hydrophobic water-based solvent, the agglomeration of pigments was not caused, and sufficient print density could not be achieved. As described above, according to the ink according to this embodiment, by including a water-based solvent having a log Kow of 0 or more, the pigments are caused to agglomerate on the paper surface, thereby improving print density.

It should be understood by those skilled in the art that various modifications, combinations, sub-combinations and alterations may occur depending on design requirements and other factors insofar as they are within the scope of the appended claims or the equivalents thereof.

What is claimed is:

1. An inkjet ink, comprising:
a pigment;
a water-based solvent;
an alkaline agent; and
a dispersion resin,
the dispersion resin being a block polymer that includes a hydrophobic polymer block including benzylmethacrylate and a hydrophilic polymer block including methacrylic acid,
the block polymer having an acid value of 120 mg KOH/g or more and 200 mg KOH/g or less, and
the water-based solvent having a log Kow of 0 or more.

2. The inkjet ink according to claim 1, wherein
a ratio of a mass of the dispersion resin to a mass of the pigment is 0.1 or more and 0.4 or less.
